(19) United States
(12) Patent Application Publication
(10) Pub. No.: US 2009/0070447 A1
(43) Pub. Date: Mar. 12, 2009

(54) ENERGY MONITORING SYSTEM USING NETWORK MANAGEMENT PROTOCOLS

(75) Inventors: Jesse Jubinville, Victoria (CA); Mike Teachman, Victoria (CA); David Anderson, Victoria (CA)

Correspondence Address: BRINKS HOFER GILSON & LIONE/PML, PO BOX 10395, CHICAGO, IL, 60610, US

(73) Assignee: POWER MEASUREMENT LTD., Saanichton (CA)

(21) Appl. No.: 11/851,471

(22) Filed: Sep. 7, 2007

(51) Int. Cl. G06F 15/173

(52) U.S. Cl. 709/223; 709/226

(57) ABSTRACT

A system and method are disclosed for integrating an intelligent electronic device (IED) in a network management system. The IED may be configured to communicate using the network management protocol of the network management system. IED variables may be mapped to associated network management protocol variables to allow the network management system to access the IED variables using the network management protocol.

### BACKGROUND

Advancements in, and demands for, technology have increased. In particular, high technology industries have increased their demands on the electrical power supplier, requiring more power, increased reliability and lower costs. A typical computer data center may use several hundred watts of energy per square foot compared to an average of 15 watts per square foot for a typical commercial building. Accordingly, the monitoring of energy usage and the detection of power quality events may be necessary for high technology industries.

Complex networks of computer and communications equipment may use a network management system to manage this equipment. One or more network management stations obtain information from the attached network devices using a network management protocol that communicates with agent software running on each device. Although network devices may offer a variety of performance data via the network management protocol, they do not have the ability to measure key parameters of the power system they are attached to.

The network management system, such as a computer network, may utilize energy meters and/or Intelligent Electronic Devices (“IED's”) to monitor energy usage. The energy meters and/or IED's may be part of an energy management system that is independent of the network management system. The energy management system may communicate with a network protocol, such as the Modbus interface. The communication within the energy management system may be independent of the network management system that is being monitored.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 illustrates an exemplary network management system;

FIG. 2 illustrates an alternate embodiment of a network management system;

FIG. 3 illustrates examples of commands for a network management system;

FIG. 4 illustrates one embodiment of mapping variables in a device;

FIG. 5 is a flowchart illustrating an exemplary mapping configuration;

FIG. 6 illustrates an exemplary mapping configuration;

FIG. 7 illustrates an exemplary IED configuration; and

FIG. 8 illustrates an alternative exemplary IED configuration.

### DETAILED DESCRIPTION

By way of introduction, the embodiments described below include a system and method for the integration of Intelligent Electronic Devices (IED) into a network management system. The embodiments relate to IED's that are configured to communicate with a network management system by utilizing the network management protocol of that system. The IED's may be installed within a network management system to measure power system parameters, as well as to monitor power system equipment responsible for maintaining a reliable supply of power. The IED supports a network management protocol and can be configured to communicate power system parameters to a network management station. The IED may be configured to map the power system parameters to corresponding network protocol variables.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below in conjunction with the embodiments.

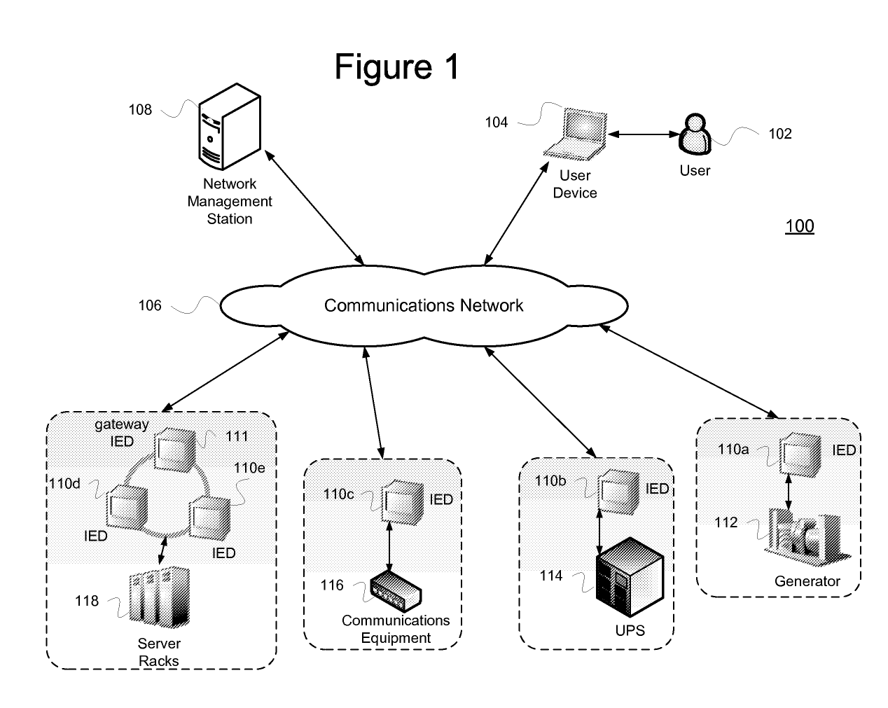

FIG. 1 illustrates an exemplary network management system 100. The network management system 100 includes a user 102 operating a user device 104 that is coupled with a network management station 108 over a communications network 106. The network management station 108 may be coupled, over the network 106,with network devices, such as a generator 112, a universal power supply (UPS) 114, communications equipment 116, and server racks 118, each of which may be coupled with at least one intelligent electronic device (IED) 110a-e. In one embodiment, a gateway IED 111 may be coupled with other IED's. Herein, the phrase “coupled with” is defined to mean directly connected to or indirectly connected through one or more intermediate components. Such intermediate components may include both hardware and software based components.

The user 102 may be an operator of the user device 104. The user 102 may interface with the network management station 108 to manage, monitor, and/or control any components or devices coupled with the communications network 106. The user 102 may not only include any individual, but a business entity or group of people. In one embodiment, the user 102 may utilize the user device 104 coupled with the network management station 108 to manage the network. In an alternative embodiment, the user 102 may utilize the user device 104 to monitor the energy usage of the network management system 100 by the IED's 110a-e and the gateway IED 111.

The user device 104 may be a computing device which allows a user to connect to the communications network 106. Examples of a user device include, but are not limited to, a personal computer, personal digital assistant (“PDA”), cellular phone, or other electronic device. The user device 104 may be configured to allow the user 102 to interact with the network management station 108 or other components of the network management system 100. The user device 104 may include a keyboard, keypad or a cursor control device, such as a mouse, or a joystick, touch screen display, remote control or any other device operative to allow interaction from the user 102.

Any of the network devices or components in the network management system 100 may be coupled with one another through a network, including but not limited to the communications network 106. Accordingly, any of the components in the network management system 100 may include communication ports configured to connect with a network.

The communications network 106 may connect any of the components in the network management system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the communications network 106 may be a public network, such as the Internet, a private network, such as an intranet, or combinations thereof, and may utilize a variety of networking protocols now available or later developed including, but not limited to TCP/IP based networking protocols. The communications network 106 may include one or more of a local area network (LAN), a wide area network (WAN), a direct connection such as through a Universal Serial Bus (USB) port, and the like, and may include the set of interconnected networks that make up the Internet. The communications network 106 may include any communication method or employ any form of machine-readable media for communicating information from one device to another. For example, the network management station 108 may receive energy measurements and/or related data any of the IED's 110a-e, or the gateway IED 111 over the communications network 106. As described, communication over the communications network 106 utilizes a network management protocol, such as Simple Network Management Protocol (SNMP) and/or Common Management Information Protocol (CMIP).

The IED's 110a-e and the gateway IED 111 may be any intelligent electronic devices (“IED's”) such as programmable logic controllers (“PLC's”), Remote Terminal Units (“RTU's”), electric/watt hour meters, protection relays and fault recorders as described below. The IED's may make use of memory and microprocessors to provide increased versatility and additional functionality. Such functionality includes the ability to communicate with remote computing systems, either via a direct connection, e.g. modem or via a network, such as the communications network 106. For more detailed information regarding IED's capable of network communication, please refer to U.S. Pat. No. 6,961,641, entitled “INTRA-DEVICE COMMUNICATIONS ARCHITECTURE FOR MANAGING ELECTRICAL POWER DISTRIBUTION AND CONSUMPTION”, U.S. Pat. No. 6,751,562, entitled “COMMUNICATIONS ARCHITECTURE FOR INTELLIGENT ELECTRONIC DEVICES”, and U.S. Pat. No. 7,216,043, entitled “PUSH COMMUNICATIONS ARCHITECTURE FOR INTELLIGENT ELECTRONIC DEVICES,” each of which is hereby incorporated by reference. In particular, the monitoring of electrical power, especially the measuring and calculating of electrical parameters, may provide valuable information for power utilities and their customers. Monitoring of electrical power may be important to ensure that the electrical power is effectively and efficiently generated, distributed and utilized. The monitoring of electrical power in real time, and responding to the monitored results in real time, can provide for cost savings in today's marketplace.

Various different arrangements are presently available for monitoring, measuring, and controlling power parameters. Typically, an IED, such as an individual power measuring device, is placed on a given branch or line proximate to one or more loads which are coupled with the branch or line in order to measure/monitor power system parameters. In addition to monitoring power parameters of a certain load(s), such power monitoring devices have a variety of other applications. For example, power monitoring devices can be used in supervisory control and data acquisition (“SCADA”) systems such as the XA/21 Energy Management System manufactured by GE Harris Energy Control Systems located in Melbourne, Fla.

As used herein, Intelligent electronic devices (“IED's”) include Programmable Logic Controllers (“PLC's”), Remote Terminal Units (“RTU's”), electric power meters, protective relays, fault recorders and other devices which are coupled with power distribution networks to manage and control the distribution and consumption of electrical power. Such devices typically utilize memory and microprocessors executing software to implement the desired power management function. IED's include on-site devices coupled with particular loads or portions of an electrical power distribution system and are used to monitor and manage power generation, distribution and consumption. IED's may also be referred to as power management devices (“PMD's”).

A Remote Terminal Unit (“RTU”) is a field device installed on an electrical power distribution system at the desired point of metering. It is equipped with input channels (for sensing or metering), output channels (for control, indication or alarms) and a communications port. Metered information is typically available through a communication protocol via a serial communication port. An exemplary RTU is the XP Series, manufactured by Quindar Productions Ltd. in Mississauga, Ontario, Canada.

A Programmable Logic Controller (“PLC”) is a solid-state control system that has a user-programmable memory for storage of instructions to implement specific functions such as Input/output (I/O) control, logic, timing, counting, report generation, communication, arithmetic, and data file manipulation. A PLC consists of a central processor, input/output interface, and memory. A PLC is designed as an industrial control system. An exemplary PLC is the SLC 500 Series, manufactured by Allen-Bradley in Milwaukee, Wis.

A meter is a device that records and measures power events, power quality, current, voltage waveforms, harmonics, transients and other power disturbances. Revenue accurate meters (“revenue meter”) relate to revenue accuracy electrical power metering devices with the ability to detect, monitor, report, quantify and communicate power quality information about the power which they are metering. An exemplary meter is the model 8500 meter, manufactured by Power Measurement Ltd, in Saanichton, B.C. Canada.

A protective relay is an electrical device that is designed to interpret input conditions in a prescribed manner, and after specified conditions are met, to cause contact operation or similar abrupt change in associated electric circuits. A relay may consist of several relay units, each responsive to a specified input, with the combination of units providing the desired overall performance characteristics of the relay. Inputs are usually electric but may be mechanical, thermal or other quantity, or a combination thereof. An exemplary relay is the type N and KC, manufactured by ABB in Raleigh, N.C.

A fault recorder is a device that records the waveform and digital inputs, such as breaker status which resulting from a fault in a line, such as a fault caused by a break in the line. An exemplary fault recorder is the IDM, manufactured by Hathaway Corp in Littleton, Colo.

IED's can also be created from existing electromechanical meters or solid-state devices by the addition of a monitoring and control device which converts the mechanical rotation of the rotary counter into electrical pulses or monitors the pulse output of the meter. An exemplary electromechanical meter is the AB1 Meter manufactured by ABB in Raleigh, N.C. Such conversion devices are known in the art.

The network management system 100 may include Intelligent Electronic Devices (“IED's”) distributed throughout the system to monitor and control the flow of electrical power to any of the components of the system. The network management system 100 may be used for monitoring, protection and control of communication devices. The system may include electrical power distribution that is monitored by IED's. IED's may be positioned along the supplier's distribution path or within a customer's internal distribution system. IED's include revenue electric watt-hour meters, protection relays, programmable logic controllers, remote terminal units, fault recorders and other devices used to monitor and/or control electrical power distribution and consumption. IED's also include legacy mechanical or electromechanical devices which have been retrofitted with appropriate hardware and/or software so as to be able to integrate with the power management architecture. Typically an IED is associated with a particular load or set of loads which are drawing electrical power from the power distribution system. The IED may also be capable of receiving data from or controlling its associated load. Depending on the type of IED and the type of load it may be associated with, the IED implements a power management function such as measuring power consumption, controlling power distribution such as a relay function, monitoring power quality, measuring power parameters such as phasor components, voltage or current, controlling power generation facilities, or combinations thereof. For functions which produce data or other results, the IED can push the data onto the communications network 106, to another IED or back end server, automatically or event driven, (discussed in more detail below) or the IED can wait for a polling communication which requests that the data be transmitted to the requester.

In addition, the IED is also capable of implementing an application component of a power management application utilizing the network management system 100. The power management application may include power management application components which are implemented on different portions of the network management system and communicate with one another via the network management system. The operation of the power management application components and their interactions/communications implement the overall power management application. One or more power management applications may be utilizing the architecture at any given time and therefore, the IED may implement one or more power management application components at any given time.

Measurement data or other data recorded, measured or monitored with the IED may be referred to as IED variables. As discussed below, IED variables may be mapped to network management protocol variables. The network management protocol variables may include communication variables and metrics (e.g. variables tracked by the network management system), including any of the variables described by the MIB definitions, such as in the MIB-II specification (RFC 1213—Management Information Base for Network Management of TCP/IP-based internets: MIB-II, by the SNMP Working Group for the IAB Official Protocol Standards and dated March 1991, which is hereby incorporated by reference). Such variables may include descriptive information for the network device (such as the IED) like sysName, sysLocation and sysContact, as well as communications-related variables such as tcpInErrs and tcpOutRsts. The IED variables include energy system variables for the equipment being monitored by the IED. Energy system variables may include an indication of the current status of the equipment being monitored, and may include a state of digital inputs monitoring equipment contacts, a real-time measurement of voltage and current, and a counter value indicating the number of voltage sag/swell events that have occurred.

The generator 112, universal power supply (UPS) 114, communications equipment 116, and server racks 118 may be additional network devices or components in the network management system 100 that are managed by the user 102 and/or the network management station 108. The components may also be managed by the corresponding IED's 110a-e and/or the gateway IED 111. In particular, the generator 112 may generate electricity for the network management system 100. The generator 112 may provide power for any of the components in the network management system 100. The energy and power quality from the generator 112 may be monitored and reported by the IED 110a. The UPS 114 may be an alternative power supply for any of the components in the network management system 100. The energy and power quality from the UPS 114 may be monitored and reported by the IED 110b. The communications equipment 116 may be monitored by the network management station 108. The communications equipment 116 may include computers, networking hardware, switching and transmission gear, base stations, or other components which may be used in the network management system 100 or other communications network. The energy and power quality from the communications equipment 116 may be monitored and reported by the IED 110c.

The server racks 118 may be a hardware computer system component configured to receive and/or send data. The server racks 118 may be computers that provide a service, such as database access, file transfer, or remote access over a network, such as the communications network 106. In addition, the server racks 118 may provide resources, such as file space, over a network, such as the communications network 106. The server racks 118 may be configured to run a server application or provide network access, such as with the Internet. The server racks 118 may include a file server, database server, backup server, print server, mail server, web server, FTP server, application server, VPN server, DHCP server, DNS server, WINS server, SMTP server, CMIP server, logon server, security server, domain controller, backup domain controller, or a proxy server. The energy and power quality from the server racks 118 may be monitored and reported by the IED 110d and/or the IED 110e. In addition, a gateway IED 111 may be coupled with the IED's 110d-e and/or the server racks 118.

The gateway IED 111 may be coupled with the other IED's 110d-e to receive data measurements that are transmitted over the communications network 106. The gateway IED 111 may be configured with communication ports for communicating with the communications network 106, whereas, the IED's 110d-e that are coupled with the gateway IED 111 may not be equipped to communicate with the communications network 106. In particular, the gateway IED 111 may be configured to communicate using the network management protocol, while the IED's 110d-e are not configured to communicate using that protocol. Accordingly, the data measured by IED's 110d-e may be transmitted to the gateway IED 111, which then transmits the data over the communications network 106 to the network management station 108 and/or the user device 104. In one embodiment, the gateway IED 111 may be referred to as a master IED and the IED's 110d-e may be referred to as slave IED's.

In one embodiment, a gateway IED may be coupled with many IED's. The IED's 110d-e may be less expensive than the gateway IED 111, so the network management system 100 may include one gateway IED 111 coupled with the other IED's 110a-e to reduce costs, but still enable the IED's 110a-e to communicate data over the communication network 106 using the network management protocol. As shown in FIG. 1 as one example, the IED's 110a-c may be configured to communicate with components in the communications network 106 using the network management protocol, but the IED's 110d-e are coupled with the gateway IED 111, which communicates with components in the communication network 106 on behalf of IED's 110d-e.

The network management station 108 may monitor and/or communicate with any of the components in the network management system 100. The network management station 108 may also be referred to as a manager and is configured to manage a plurality of managed devices. In particular, the network management station 108 communicates using a network management protocol. For example, the network management protocol communication may include the Simple Network Management Protocol (SNMP), the Common Management Information Protocol (CMIP), or any other network management protocol that is configured for communications in a network management system. As described, a network management system, such as system 100, includes devices that are coupled to a network that are monitored and managed by a manager (such as the network management station 108) using a network management protocol. The network management station 108 may collect and store information regarding any of the devices on the network. In one embodiment, the network management station 108 may be operated by a human network manager (not shown). The human network manager may interface with the network management station 108 to determine the status of the network management system 100 or to access any of the stored information regarding the devices on the network.

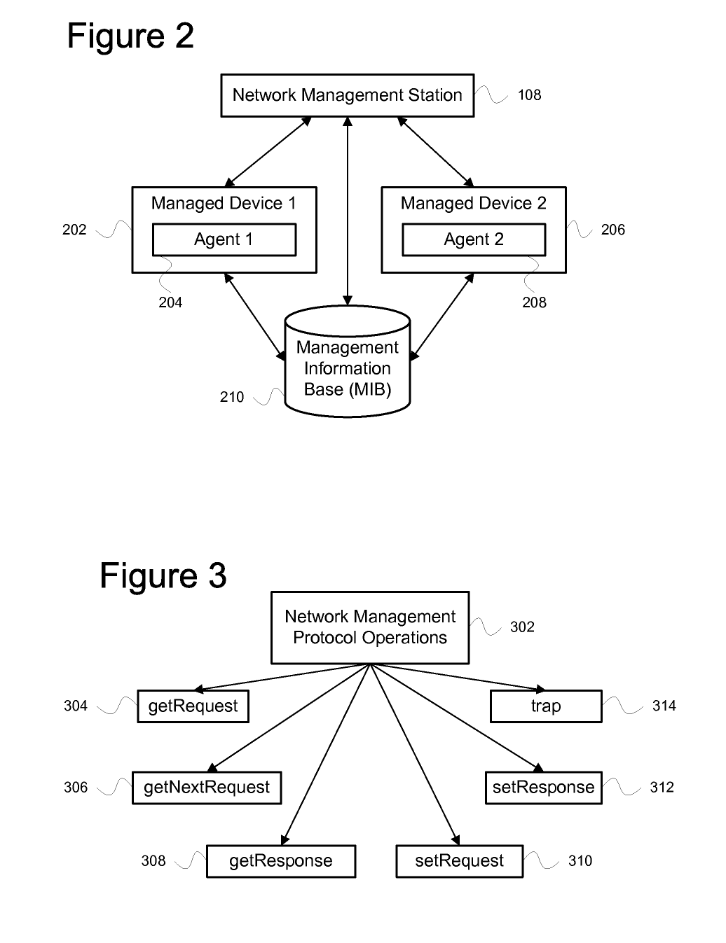

FIG. 2 illustrates an alternate embodiment of a network management system. In particular, the network management station 108 is coupled with a first managed device 202, a second managed device 206, and a management information base 210. The network management station 108 manages both the first and second managed devices 202, 206 by communicating using a network management protocol. In one example, the managed devices 202, 206 may be the generator 112, universal power supply (UPS) 114, communications equipment 116, and/or the server racks 118 discussed above. In addition, the managed devices 202, 206 may include computers, routers, access servers, computer hosts, hubs, printers, and/or other computing devices. In a network management system, there may be any number of network management stations and any number of managed devices.

In order to communicate through a network management protocol, such as SNMP, the managed devices 202, 206 may include a first agent 204 and a second agent 208, respectively. The agents 204, 208 may be a network management software module that resides in the managed devices 202, 206, respectively. The agents 204, 208 may interpret network management protocol communications for communicating information about the managed devices 202, 206. In one embodiment, the agent is an interface between the network management station and the device that is being managed. In other words, the agents 204, 208 are interfaces for communication between the network management station 108 and the managed devices 202, 206, respectively. The agent in a managed device may be responsible for interpretation and handling of the network management station requests to the managed device and for the generation of properly-formatted responses (using the network management protocol) to the network management station.

An IED may be coupled with each of the managed devices 202, 206 for monitoring the energy usage of the managed devices as shown in FIG. 1. Alternatively, the IED may be a managed device that is configured to communicate with the network management station 108 using the network management protocol. Referring to FIG. 1, the IED's 110a-e and the gateway IED 111 may be managed devices that are configured to communicate using a network management protocol with the network management station 108. In an alternative embodiment, the IED's 110d-e are not configured to communicate using a network management protocol with the network management station 108, but are instead coupled with the gateway IED 111, which can communicate with the network management station 108 using the network management protocol.

The gateway IED 111 may act as a gateway between the network management system and other devices, such as IED's 110d-e. The IED's 110d-e may report to and provide data to the gateway IED 111. Likewise, if the network management station 108 requests data from the IED's 110d-e, then that request may be sent to the gateway IED 111 using the network management protocol. The gateway IED 111 then receives the data from the IED's 110d-e using the IED's communication protocol and transmits that data to the network management station 108. In other words, the gateway IED 111 is a managed device that reports data and information for itself and for the IED's 110d-e to the network management station 108. The data and information may include any energy or power parameters that are monitored by an IED as discussed.

The gateway IED 111 may be configured to translate network management system requests from the network management station 108 into a protocol supported by the coupled IED's 110d-e. The gateway IED 111 then translates the response from the IED's 110d-e back into the network management protocol to communicate the response to the network management station 108. In an alternative embodiment, the gateway IED 111 may poll the IED's 110d-e and cache the acquired data. The gateway IED 111 may then provide the cached data to the network management system on request from the network management station 108. Alternatively, the gateway IED 111 may provide the cached data as an ad-hoc notification when preconfigured conditions are met.

Referring back to FIG. 2, the management information base (MIB) 210 may be coupled with the network management station 108, the first managed device 202, and/or the second managed device 206. In one embodiment, the network management station 108, the first managed device 202, the second managed device 206 and any other device may each have its own MIB. The MIB 210 includes a collection of managed objects. The managed objects may be any variable, parameter or value that can be managed.

The MIB 210 for each managed device stores management information that may be available to a manager, such as the network management station 108. The management information in an MIB may be related to the device using the MIB. In one embodiment, the MIB 210 is stored on the managed device. Alternatively, the MIB 210 may be accessible to the manager regardless of its storage. In one example, when an IED is a managed device, the managed objects stored in the IED's MIB may include energy measurements and power quality data measured by the IED. In one embodiment, the MIB 210 may be a structured text file that describes the variables available on a managed device to a network management station. In the case of an IED, the MIB may describe IED variables or parameters.

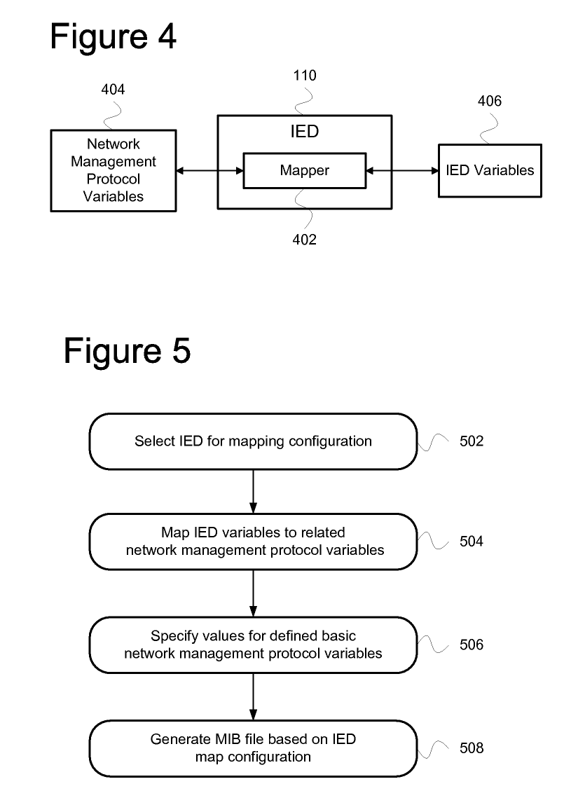

The MIB 210 may store network management variables that may be accessed by the network management station 108. In particular, the MIB 210 may describe a set of network management protocol variables that are available on a network device, and the network management station 108 may utilize the MIB 210 to determine which variables are available. In an alternative embodiment, one network device may have more than one MIB associated with it, and each MIB may describe a different set of variables offered by the network device. The network management variables may establish an alias for other variables from the managed device. For example, an IED managed device may include IED variables that are stored or referenced by the network management variables. A request for a network management variable would return the current value of the associated IED variable. The association of network management variables and IED variables is discussed further in FIGS. 4-8.

The management network protocol that is used for managing enables a manager to communicate with managed devices utilizing that managed device's MIB. The manager may perform management operations with a managed device based on that device's MIB. The accessing of a device's MIB may require communication by a network management protocol, such as SNMP.

A set of commands may be used to access the information or managed objects that are described in the MIB 210 of any device. The commands may be network management protocol operations 302 as shown in FIG. 3. For example, the network management protocol operations 302 may include a getRequest command 304, a getNextRequest command 306, a getResponse command 308, a setRequest command 310, a setResponse command 312, and/or a trap command 314.

The getRequest command 304 may be issued by the network management station 108 to request information for a particular variable or managed object from a managed device, such as the managed devices 202, 206. The variable or managed object from the managed device is described by the MIB of that managed device. Upon receiving the getRequest command 304, the agent of the managed device may issue a getResponse command 308 to the requester (the network management station 108) with the requested information or with an indication of an error, if the request cannot be processed.

In one embodiment, the getRequest command 304 may be used for the auto discovery of any IED's on the network, including IED's coupled with managed devices on the network. The auto-discovery getRequest command may be used by the network management station 108 to determine the locations and/or status of active IED's and/or managed devices, which may then be stored in a database of active devices.

The auto-discovery operation may also probe network devices for additional information. Auto-discovery may be used to provide information that differentiates IED's from other network devices within the network management system 100. In one embodiment, the network management station 108 may identify a network device as an IED when it receives a valid response after sending a probing request to a specific TCP/IP port uniquely supported by IED's. In an alternative embodiment, at least a portion of the contents of a network management protocol variable offered by IED's may be used to provide this differentiation. For example, some portion of the contents of the sysName variable defined by the MIB-II specification (referenced above) may contain an identifying string that would consistently be used by all IED's.

The getNextRequest command 306 may be sent by the network management station 108 for receiving sequentially specific management information from the managed device. The managed device may respond to the getNextRequest command 306 with a getResponse command 308 to the network management station 108 with the requested sequentially specific information or with an indication of an error.

The setRequest command 310 allows the network management station 108 to request a change to any variable or managed object stored with the managed object, such as within the MIB of the managed object. The managed device may respond to a setRequest command 310 with a setResponse command 312. The setResponse command 312 is sent from the managed device to the network management station 108 with an indication that the requested change has been made to the variable(s) or managed object(s) or with an indication of an error.

The trap command 314 may be sent from an agent of a managed device without being prompted by the manager. For example, the first agent 204 of the first managed device 202 may send a trap command 314 to the network management station 108 without being initiated to do so. The trap command 314 may be used as an alarm for notification of any problems by any of the managed devices. For example, in FIG. 1, the communications equipment 116 (managed device) may notify the network management station 108 of any equipment or data failure. In addition, the IED 110c (managed device) may issue a trap command 314 to the network management station 108 upon any power failure or other power quality event.

As described, FIG. 3 illustrates examples of commands for a network management system. As described above, each of the network management protocol operations 302 is based on a request or polling form the network management station, except for the trap command 314, which may be initiated by the managed device. The network management protocol operations 302 are merely exemplary. Additional or fewer commands may also be provided, including any commands utilized in an SNMP, CMIP, or other network management system.

FIG. 4 illustrates one embodiment of mapping variables in a device. The IED 110 may include a mapper 402. The mapper 402 may comprise a power management application that is configured to associate IED variables 406 with related network management protocol variables 404 and storing this mapped relationship on the IED. When the network management station 108 requests a specific network management protocol variable from an IED using a network management protocol, the IED checks the map to determine which associated IED variable is required and responds with that variable using the network management protocol to communicate with the network management station 108.

The network management protocol variables 404 may be stored in management information base (MIB) of a device. The network management protocol variables 404 may be communicated using a network management protocol, such as SNMP. In one embodiment, the network management protocol variables 404 may be those variables used in the SNMP network management protocol. Additional variables are identified in the MIB-II specification mentioned above.

The IED variables 406 may include any energy measurement or power quality data. For example, the current, voltage, power, and corresponding time may be IED variables 406. IED variables may include the on/off status of IED digital inputs that are connected to output relays on the equipment being monitored, which is a configuration that is often used to monitor the operating status of the equipment. IED variables may further include counters that track the number of voltage sag/swell events or voltage transient events that the equipment being monitored has been subjected to since the time the counters were last reset.

FIG. 5 is a flowchart illustrating an exemplary mapping configuration. In block 502, an IED is selected to generate a mapping configuration. In one embodiment, the IED 110 utilizes the mapper 402 to develop an association between the IED variables 406 and the network management protocol variables 404. In block 504, the IED variables 406 are mapped to related or associated network management protocol variables 404. In block 506, values are specified for defined basic network management protocol variables. Some network management protocols may require that network devices contain defined basic variables that do not have equivalent IED variables. In addition to linking IED variables with network management protocol variables, a map configuration stored on the IED may also contain network management protocol variables that a user can set directly. After the map configuration for the IED has been completed, a management information base (MIB) file is generated that defines the network management protocol variables offered by the map configuration as in block 508. The network management station may use this file to build a database of variables offered by all managed network devices.

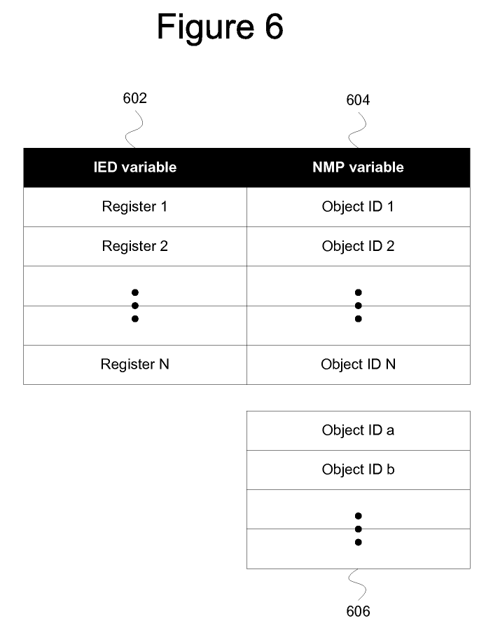

FIG. 6 illustrates an exemplary mapping configuration. The map configuration may be organized as a table with an IED column 602 and network management protocol column 604. Each row in the table maps a relationship between a specific IED register and a related network management protocol object. In one embodiment, a user may enter register IDs and object IDs into a table to define the relationship between IED variables and network management protocol variables. The map configuration may also list additional network management protocol variables 606 that do not have equivalent IED variables and that may be set to a static value directly by a user.

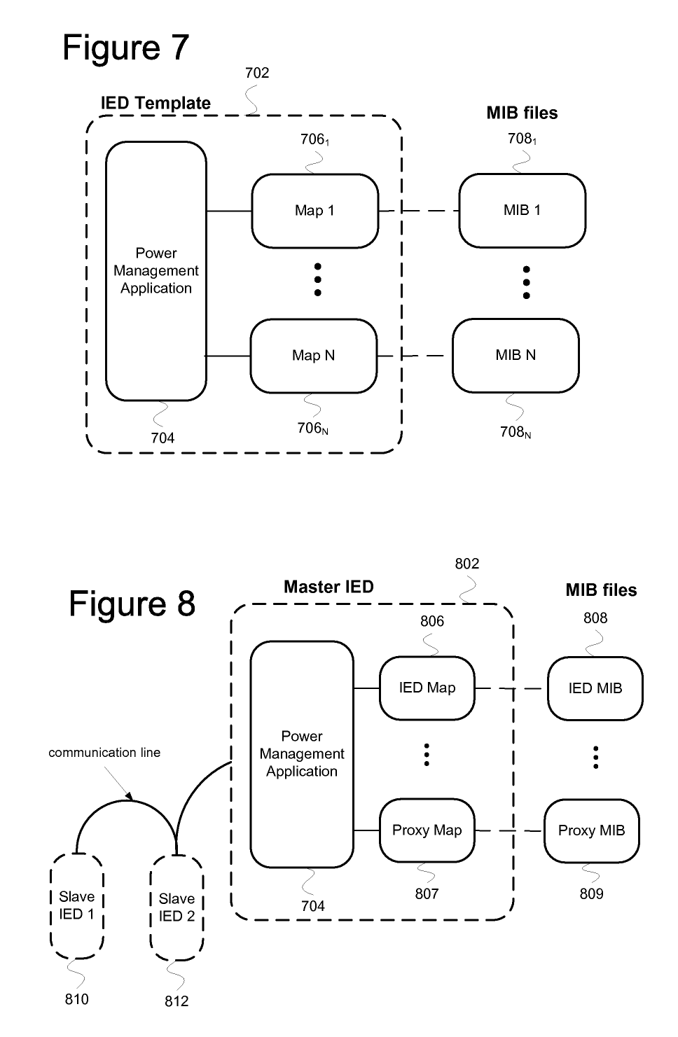

FIG. 7 illustrates an exemplary IED configuration. An IED template 702 may include a power management application 704, which may define IED measurements and actions as discussed above. The power management application 704 may be used by an end user, such as user 102, to define certain measurements in an IED. While certain measurements in an IED may be fixed within firmware (such as voltage and current); others may be defined by end users by linking basic measurements into functional blocks. For example, a kW measurement may be linked into an Integrator block to define the kW*h measurement. The IED template 702 may also include at least one map configuration 706₁, and may include up to n map configurations 706_{N}. Each map configuration 706 may have an associated MIB file 706₁-706_{N} that describes the network management protocol variables available in the map. The MIB may be provided to the network management station 108. Once a complete IED configuration 702 has been built, the template file for this configuration may be downloaded to other IED's and the associated MIB files transferred to the relevant network management stations.

FIG. 8 illustrates an alternative exemplary IED configuration. In particular, a master IED 802 may be configured to communicate with a network management protocol, while a first slave IED 810 and a second slave IED 812 may not communicate using the network management protocol. The master IED 802 may read data from one or more slave IED's, such as the slave IED's 810, 812, using their native communications protocol and store this data within internal registers. These registers may be associated with management protocol objects using at least one proxy map 807, and each proxy map has an associated proxy MIB file 809. Alternatively, the proxy MIB file 809 may be accessible by the network management station 108 regardless of the storage location. In one example, the MIB file 809 may be used temporarily and not stored permanently. The network management station 108 makes use of the proxy MIB file 809 to query the master IED 802 and receive information relating to one or more slave IED's 810, 812 attached to the master IED 802. The proxy map 807 and proxy MIB file 809 may be separate from the IED map 806 and the IED MIB file 808 that represent measurements performed directly by the master IED 802 itself.

The mapping described above may provide increased flexibility to a customer monitoring a network system. The IED's that monitor the energy usage of the network system equipment may be controlled and monitored using the same network communication protocol that is used to communicate with the network system equipment. The common protocol may allow the network administrator to also monitor the energy and power quality variables of the network equipment. The customer may be able to generate a mapping to monitor the energy and power quality variables that are important to that customer. The customer may be provided with a model of a potential mapping and be able to customize that mapping to identify different energy and power quality variables. The IED's then measure the relevant variables and are monitored by the customer using the customer-generated mapping. In addition, the mapping may be modified or adjusted to fit the changing needs of a customer. For example, a customer may have different energy needs and concerns as the network system grows in size.

In one embodiment, the mapping that is generated or developed by one customer may be used by other customers, even when the other customers have a different mapping. The defined variables that are mapped by a first customer may be translated into the defined variables that are mapped by a second customer. The MIB files for a customer may improve scalability. In particular, the MIB files of multiple customers may be translated, such that the customers may communicate using the same network communication protocol. In one embodiment, a first customer merging its network system (with a first MIB mapping) with a second network system (with a different MIB mapping) may be translated so that both MIB mappings may be unified and the combined system will have a single mapping that communicates with all the equipment and IED's in both of the network systems.

The methods discussed above may be encoded in a signal bearing medium, a computer readable medium such as a memory, programmed within a device such as one or more integrated circuits, one or more processors or processed by a controller or a computer. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A system for network management communication comprising:
a communications network;
an intelligent electronic device (IED) coupled with the communications network and including a plurality of IED variables, wherein the IED is configured to measure data, the measured data being stored in at least one of the plurality of IED variables, the IED comprising:
an agent configured to communicate using a network management protocol, the network management protocol including a plurality of network management protocol variables; and
a mapper configured to associate the at least one IED variable with at least one of the plurality of network management protocol variables; and
a network management station coupled with the communications network and configured to access the at least one network management protocol variable using the network management protocol.

2. The system of claim 1 wherein the system further comprises:
a management information base coupled with the IED and the network management station that describes a set of the plurality of network management protocol variables offered by the IED.

3. The system of claim 2 wherein the management information base is generated based on the mapped association between the plurality of IED variables and the plurality of network management protocol variables.

4. The system of claim 1 wherein the mapped association between the plurality of IED variables and the plurality of network management protocol variables is transferable to other IED's to establish the associations on the other IED's.

5. The system of claim 1 wherein the IED further comprises a power management application that measures the data.

6. The system of claim 1 wherein the network management station is configured to automatically discover other IED's coupled with the communications network.

7. The system of claim 1 wherein the agent comprises an interface between the network management station and the IED.

8. The system of claim 1 wherein at least one of the IED variables is associated with an alarm event generated by the IED and is mapped to at least one of the network management protocol variables with a trap command that notifies the network management station of generation of the alarm event by the IED.

9. The system of claim 1 wherein the measured data of the IED includes energy measurement data.

10. The system of claim 1 further comprising:
a slave IED coupled with the IED, wherein at least a portion of the plurality of IED variables of the IED include data obtained from the slave IED.

11. An intelligent electronic device (IED) comprising:
a sensor for measuring data;
a power management application coupled with the sensor and configured to record the data measured by the sensor, wherein the measured data comprises a plurality of IED variables;
a management information base including a plurality of network management protocol variables, wherein the plurality of network management protocol variables are used for communication in a network management system; and
a map that associates the plurality of IED variables with the plurality of network management protocol variables.

12. The IED of claim 11 further comprising a communication port configured to connect with the network management system and a network management station in the network management system.

13. The IED of claim 12 further comprising an agent that communicates at least one of the plurality of IED variables to the network management station upon receiving a request for the at least one of the plurality of network management protocol variables that is associated with the at least one of the plurality of IED variables according to the map.

14. The IED of claim 13 wherein the network management station includes at least one management information base describing a set of the network management protocol variables offered by the IED.

15. The IED of claim 12 wherein at least one of the plurality of IED variables is associated with an alarm event generated by the IED and is further mapped to at least one of the plurality of network management protocol variables with a trap command that notifies the network management station of the generation of the alarm event by the IED.

16. A method for integrating an intelligent electronic device (IED) into a network management system, the method comprising:
providing a plurality of IED variables, wherein each of the plurality IED variables is operative to store measurement data from the IED;
communicating with the network management system using a network management protocol which utilizes a plurality of network management protocol variables for the communication;
associating each of the plurality of IED variables to a related one of the plurality of network management protocol variables;
storing the association of the plurality of IED variables in a map;
receiving a request for at least one of the plurality of network management protocol variables; and
providing, in response to the request, at least one of the plurality of IED variables that is associated with the requested at least one network management protocol variable according to the map.

17. The method of claim 16 further comprising:
editing the map to modify the association for a particular IED variable with a particular network management protocol variable.

18. The method of claim 16 further comprising:
generating an alarm condition on the IED based on the measurement data; and
sending a trap command to the network management system based on the generating.

19. The method of claim 16 wherein the management information base describes the plurality of network management protocol variables offered by the IED.

20. The method of claim 19 wherein the management information base is accessible by a network management station for communicating with the IED using the network management protocol.

21. The method of claim 16 further comprising:
measuring energy data, wherein the measurement data comprises the measured energy data.
